(19) United States
(12) Patent Application Publication
(10) Pub. No.: US 2008/0192229 A1
(43) Pub. Date: Aug. 14, 2008

(54) Relative Movement Sensor Comprising Multiple Lasers

(75) Inventors: Alphons Antonius Maria Lambertus Bruekers, Eindhoven (NL); Cristian Presura, Eindhoven (NL); Antonius Hermanus Maria Akkermans, Eindhoven (NL); Thomas Andreas Maria Kevenaar, Eindhoven (NL); Minne Van Der Veen, Eindhoven (NL); Marijn Christian Damstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,475

(22) PCT Filed: Mar. 29, 2006
(86) PCT No.: PCT/IB2006/050953

§ 371 Date: Oct. 2, 2007

(30) Foreign Application Priority Data
Apr. 7, 2005 (EP) 05102732.4

(51) Int. Cl. G01P 3/36

(52) U.S. Cl. 356/28

(57) ABSTRACT

A relative movement sensor for measuring movement of an object (15) and the sensor relative to each other, the sensor comprising a plurality of lasers (3,5) for generating respective measuring beams and illuminating the object (15) therewith, and a plurality of respective photodiodes (4,6) for measuring changes in operation of each laser cavity caused by reflected measuring beam radiation re-entering the respective laser cavity and the optical wave in the laser cavity. The plurality of lasers (3,5) are operated in a time-multiplexed manner such that only a subset (i.e. one or more) of the lasers is operated at any one time, the remaining lasers being idle. This reduces peak power dissipation and prevents erroneous interference caused by measuring beam radiation from one laser entering the cavity of another laser.

This invention relates to a relative movement sensor for use in, for example, an optical input device, for measuring movement of an object (for example, a user's finger, other body part, or an inanimate object such as a work surface or sheet of material) or other substance (such as a liquid or gas containing particulate material) and the sensor relative to each other, the sensor being of the type comprising two or more lasers, each having a laser cavity, for generating a respective measuring beam and illuminating an object or substance therewith, wherein at least some of the measuring beam radiation reflected by the object or substance re-enters the respective laser cavity, and wherein measuring means are provided for measuring changes in operation of the laser cavity caused by interference of the reflected measuring beam radiation re-entering the respective laser cavity and the optical wave in that cavity.

The invention also relates to a method of measuring movement of an object or substance and such a sensor relative to each other.

An optical input device including a relative movement sensor such as that defined above is known from International Patent Application No. 02/37410, which describes a method of measuring the relative movement of an input device and an object, for example a human finger or other object, which method uses a so-called self-mixing effect in a diode laser. This is the phenomenon that radiation emitted by a diode laser and re-entering the cavity of the diode laser induces a variation in the gain of the laser and thus in the radiation emitted from the laser. Radiation emitted by a diode laser is focused through, for example, a plastic lens on an external object (for example, a fingertip). The light scatters and a small part re-enters the cavity of the laser. Here, the light that is scattered mixes coherently with the light inside the cavity, which changes the gain and frequency of the laser. This self-mixing can be detected and converted to represent the direction and speed of relative movement of the device and object.

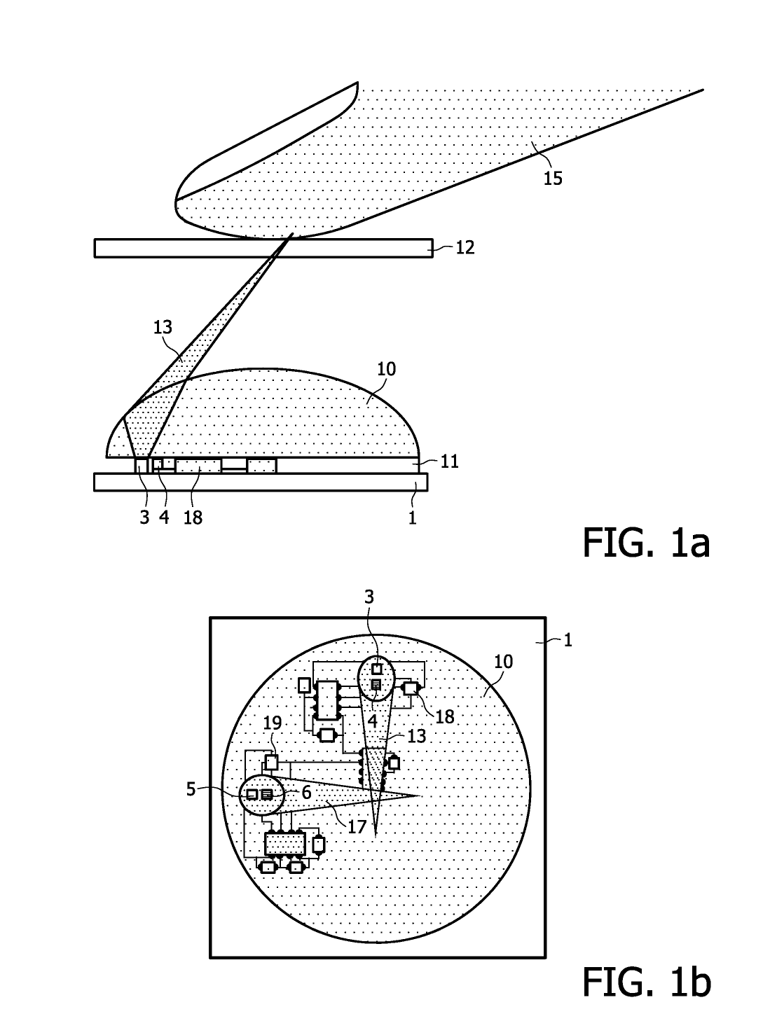

FIG. 1a is a diagrammatic cross-section of an optical input device comprising, at its lower side, a base plate 1, which is a carrier for the diode lasers, which may be lasers of the Vertical Cavity Surface Emitting Laser (VCSEL) type, and the detectors, for example, photo diodes. In FIG. 1a only one diode laser 3 and its associated photo diode is visible, but usually at least a second diode laser 5 and associated detector 6 is provided on the base plate 1, as shown in FIG. 1b of the drawings. The diode lasers 3, 5 emit laser, or measuring, beams 13 and 17 respectively. At its upper side, the device is provided with a transparent window (e.g. plastic lens) 12 across which an external object 15, for example, a human fingertip is to be moved. A lens 10, for example, a plano-convex lens is arranged between the diode lasers and the window. This lens focuses the laser beams 13, 17 at or near the upper side of the transparent window. If an object 15 is present at this position, it scatters the beam 13, 17. A part of the radiation of beam 13, 17 is scattered in the direction of the illumination beam 13, 17 and this part is converged by the lens 10 on the emitting surface of the diode laser 3, 5 and re-enters the cavity of this laser. The radiation re-entering the cavity induces a variation in the gain of the laser and thus in the radiation emitted by the laser. This phenomenon will also be referred to herein as the so-called self-mixing effect in a diode laser.

The finger and the input device are moved relative to each other such that the direction of movement has a component in the direction of the laser beam. Upon movement of the finger and the input device, the radiation scattered by the object gets a frequency different from the frequency of the radiation illuminating the object, because of the Doppler effect. Part of the scattered light is focused on the diode laser by the same lens that focuses the illumination beam on the finger. Because some of the scattered radiation enters the laser cavity through the laser mirror, interference of light takes place in the laser. This gives rise to fundamental changes in the properties of the laser and the emitted radiation. Parameters, which change due to the self-coupling effect, are the power, the frequency and the line width of the laser radiation and the laser threshold gain. The result of the interference in the laser cavity is a fluctuation of the values of these parameters with a frequency that is equal to the difference of the two radiation frequencies. This difference is proportional to the velocity of the fingertip. Thus, the velocity of the fingertip and, by integrating over time, the displacement of the fingertip, can be determined by measuring the value of one of the above-mentioned parameters.

The change of intensity of the laser radiation emitted by the diode laser as a result of relative movement between the fingertip and the input device can be detected by the photo diode 4, 6, which converts the radiation variation into an electric signal, and electronic circuitry 18, 19 is provided for processing this electric signal.

The principle of the relative movement sensor and method of measuring relative movement employed in the present invention is described in further detail in International Patent Application No. 02/37410, and will not be described in any further detail herein.

Thus, in order to enable relative movement to be measured in several directions, or to enable more accurate measurement results, two or more diode lasers and corresponding detectors may be used. In general, the use of multiple lasers may result in light from one laser entering the laser cavity of another diode laser. In practice, the wavelengths of different lasers may differ sufficiently due to tolerances in the production process so as to avoid any problems being caused by light from one diode laser entering the cavity of another diode laser. However, when the number of lasers is further increased and/or the lasers are provided on the same chip, the interference may become significant to the extent that the signal-to-noise ratio may be increased or, depending on the temporal cherence property of the lasers, erroneous interference may occur which will adversely affect the accuracy of the relative movement measurement.

It is therefore an object of the present invention to provide a relative movement sensor of the type defined above, having two or more lasers and corresponding detectors, in which the likelihood of light from one laser entering the cavity of another laser and causing interference therein is at least reduced.

In accordance with the present invention, there is provided a relative movement sensor for measuring movement of an object or other substance and said sensor relative to each other along at least one measuring axis, the sensor comprising a plurality of lasers, each having a corresponding laser cavity, for generating respective measuring beams and illuminating an object or other substance therewith, wherein at least some of the measuring beam radiation reflected by said object or other substance re-enters the respective laser cavity, the apparatus further comprising means for measuring changes in operation of each said laser cavity caused by interference of reflected measuring beam radiation re-entering said respective laser cavity and the optical wave in said laser cavity, and means for providing an electrical signal representative of said changes, wherein means are provided to selectively operate at any one time a subset of said plurality of lasers to generate a subset of respective measuring beams, while the remaining lasers are substantially inactive.

Also in accordance with the present invention, there is provided a method of measuring movement of an object or other substance and a relative movement sensor relative to each other along at least one measuring axis, the method comprising providing a plurality of lasers, each having a corresponding laser cavity, for generating respective measuring beams and illuminating an object or other substance therewith, wherein at least some of the measuring beam radiation reflected by said object re-enters the respective laser cavity, providing means for measuring changes in operation of each said laser cavity caused by interference of reflected measuring beam radiation re-entering said respective laser cavity and the optical wave in said laser cavity, and providing means for providing an electrical signal representative of said changes, the method further comprising selectively operating, at any one time, a subset of said plurality of lasers to generate a subset of respective measuring beams, while the remaining lasers are substantially inactive.

Thus, the plurality of lasers are operated in a time-multiplexed manner, such that only a subset thereof is active at any one time, such that peak power dissipation is reduced (i.e. averaged) and, more importantly, a laser captures less light emitted by any of the other lasers relative to the prior art arrangements, thereby eliminating the problems associated with the above-mentioned interference.

In a preferred embodiment, time multiplexing means is provided for directing (randomly or periodically), under control of a timing signal, current to a selected subset of the plurality of lasers, whilst little or no current is supplied to the remaining lasers. Multiplexing means may also be provided for causing response signals generated by the respective measuring means, and originating from each said subset of lasers, to be individually processed to generate a respective electrical signal.

These and other aspects of the present invention will be apparent from, and elucidated with reference to, the embodiment described herein.

An embodiment of the present invention will now be described by way of example only and with reference to the accompanying drawings, in which:

FIG. 1a is a schematic cross-sectional view of an optical input device of the type described in International Patent Application No. 02/37410, to illustrate the principle of operation of a relative movement sensor according to an exemplary embodiment of the present invention;

FIG. 1b is a plan view of the device of FIG. 1a;

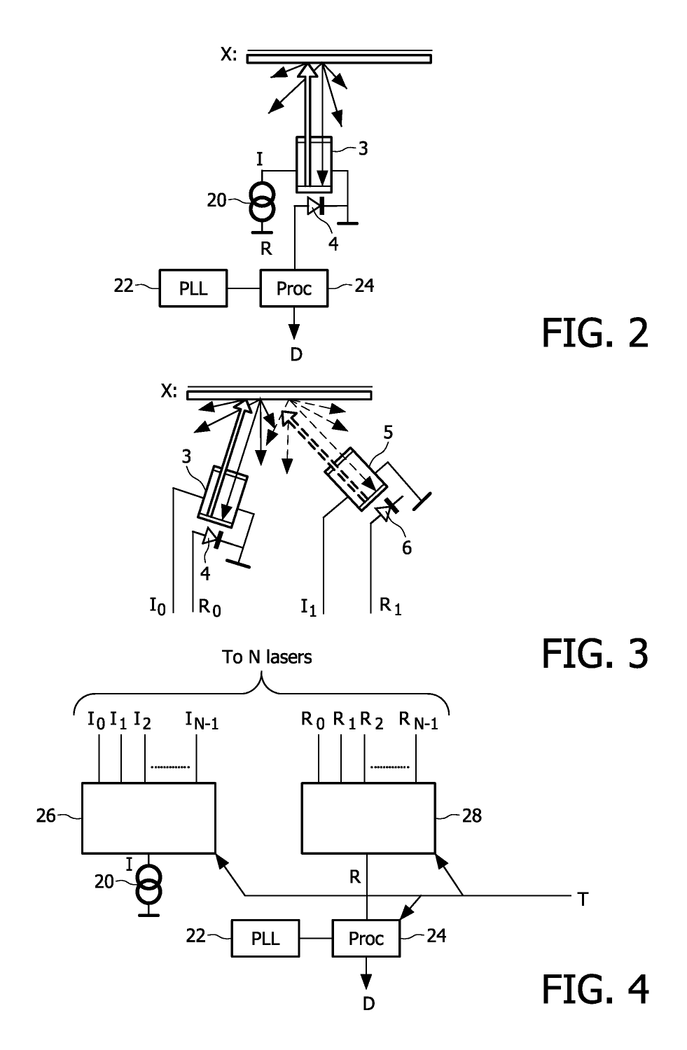

FIG. 2 is a schematic illustration of a relative movement sensor according to the prior art, in which a single laser/photodiode subsystem is employed;

FIG. 3 is a schematic illustration of a relative movement sensor in which two laser/photodiode subsystems are employed; and

FIG. 4 is a schematic diagram illustrating the configuration of a control system for use in a relative movement sensor according to an exemplary embodiment of the present invention, comprising N laser/photodiode subsystems (where N≧2).

Thus, referring to FIG. 2 of the drawings, the laser-based relative movement sensor described in International Patent Application No. 02/37410 can be used to measure movements of a light scattering plane X. The laser 3 is fed from a current source 20 with current I and emits light in the direction of plane X. Part of the light is scattered by the plane back into the laser 3 where the incoming light interferes with the outgoing light. The resulting interference depends on the distance between the laser 3 and the plane X (self-mixing interferometry). Also, the speed of movement of the plane X with respect to the laser 3 is relevant due to the related Doppler shifts. The monitoring photodiode 4 measures the time-varying interference R and, together with a phase locked loop (PLL) 22 and appropriate processing (denoted by reference numeral 24), output data D is generated that describes the movements of the plane. A more detailed of the underlying principle of operation of this relative movement sensor is provided in WO02/37410, and will not be further discussed herein.

In order to enable relative movement to measured in other directions and/or to improve the accuracy of measurement, two lasers 3,5 and corresponding photodiodes 4,6 may be employed, as illustrated schematically in FIG. 3 of the drawings. However, if the number of lasers 3,5 and corresponding photodiodes 4,6 is further increased and/or the multiple lasers are provided on the same chip, the interference caused by light from one laser entering the cavity of another laser may become significant so as to adversely affect the signal-to-noise ratio or, depending on the temporal coherence property of the lasers, the accuracy of the output data D.

Thus, the principle underlying the present invention is to employ N lasers (in a time-multiplexed manner) and corresponding N photodiodes, wherein N is an integer greater than 1. As a result, not all N lasers are active at any one time such that the peak power dissipation is reduced (i.e. averaged) and, more importantly, each laser re-captures less light emitted by any of the other lasers relative to prior art arrangements. An exemplary configuration is illustrated schematically in FIG. 4 of the drawings, wherein the N lasers and corresponding photodiodes are omitted for clarity. A current multiplexer 26 is employed which, under control of a timing signal T, directs the current I generated by the current source 20 to a subset (i.e. one or more) of the N lasers in the form of respect of currents Iᵢ (where i=0 to N−1). In one exemplary embodiment, a device may comprise two or more relative movement sensors, each having N lasers, in which case, it is envisaged that a subset (i.e. zero or more) of the lasers of each of the sensors may be arranged to be active at any one time, with the remaining lasers being inactive.

In any event, the resulting response signals Rᵢ derived from the respective photodiodes are caused by a response multiplexer 28, also under control of the timing signal T, to be processed individually by the processor 24. In this configuration, it is possible for a phase locked loop (PLL) system 22 to be shared between the N laser/photodiode subsystems, which gives a further reduction in power and costs.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A relative movement sensor for measuring movement of an object (15) or other substance and said sensor relative to each other along at least one measuring axis (X), the sensor comprising a plurality of lasers (3,5), each having a corresponding laser cavity, for generating respective measuring beams (13,17) and illuminating an object (15) or other substance therewith, wherein at least some of the measuring beam radiation reflected by said object (15) or other substance re-enters the respective laser cavity, the apparatus further comprising means (4,6) for measuring changes in operation of each said laser cavity caused by interference of reflected measuring beam radiation re-entering said respective laser cavity and the optical wave in said laser cavity, and means (24) for providing an electrical signal representative of said changes, wherein means (26) are provided to selectively operate at any one time a subset of said plurality of lasers (3,5) to generate a subset of respective measuring beams (13,17), while the remaining lasers (3,5) are substantially inactive.

2. A sensor according to claim 1, wherein time multiplexing means (26) is provided for directing, under control of a timing signal (T), current (Iᵢ) to a selected subset of the plurality of lasers (3,5), whilst little or no current is supplied to the remaining lasers.

3. A sensor according to claim 2, wherein time multiplexing means (26) is provided for periodically directing, under control of a timing signal (T), current (Iᵢ) to a selected subset of the plurality of lasers (3,5), whilst little or no current is supplied to the remaining lasers.

4. A sensor according to claim 2, wherein multiplexing means (28) are provided for causing response signals (R) generated by the respective measuring means (4,6), and originating from each said subset of lasers (3,5), to be individually processed to generate a respective electrical signal (D).

5. A controller for the relative movement sensor of claim 1, arranged and configured to generate a control signal for selectively operating at any one time a subset of said plurality of lasers (3,5) to generate a subset of respective measuring beams (13,17), while the remaining lasers (3,5) are substantially inactive.

6. A control signal generated by the controller of claim 5, arranged to selectively operate at any one time a subset of said plurality of lasers (3,5) to generate a subset of respective measuring beams (13,17), while the remaining lasers (3,5) are substantially inactive.

7. A method of measuring movement of an object (15) or other substance and a relative movement sensor relative to each other along at least one measuring axis (X), the method comprising providing a plurality of lasers (3,5), each having a corresponding laser cavity, for generating respective measuring beams (13,17) and illuminating an object (15) or other substance therewith, wherein at least some of the measuring beam radiation reflected by said object or other substance re-enters the respective laser cavity, providing means (4,6) for measuring changes in operation of each said laser cavity caused by interference of reflected measuring beam radiation re-entering and respective laser cavity and the optical wave in said laser cavity, and providing means (24) for providing an electrical signal (D) representative of said changes, the method further comprising selectively operating, at any one time, a subset of said plurality of lasers (3,5) to generate a subset of respective measuring beams (13,17), while the remaining lasers are substantially inactive.
